(19) United States
(12) Patent Application Publication
(10) Pub. No.: US 2022/0217921 A1
(43) Pub. Date: Jul. 14, 2022

(54) Light Bib

(71) Applicant: Earle Bryant Wedemeyer, Sutton, VT (US)

(72) Inventor: Earle Bryant Wedemeyer, Sutton, VT (US)

(21) Appl. No.: 17/647,589

(22) Filed: Jan. 10, 2022

Related U.S. Application Data
(60) Provisional application No. 63/205,816, filed on Jan. 11, 2021.

(51) Int. Cl. A01G 13/02

(52) U.S. Cl. CPC A01G 13/0237

(57) ABSTRACT

A flat flexible mirrored disk with portions removed to allow transformation into a conical mirror that can be placed around and removed from a plant's stalk. Conical mirror redirects wasted light back into plant canopy.

### BACKGROUND

This invention is applied light reflectivity for utilization in agriculture.

### BRIEF SUMMARY

Using an inverted cone made of a flexible reflective mirrored surface, positioned around the stock of a plant, light energy that is not initially absorbed by plant leaves, but would be absorbed by the growing medium (soil) is reflected back up and into the plant canopy.

### DESCRIPTION OF DRAWINGS

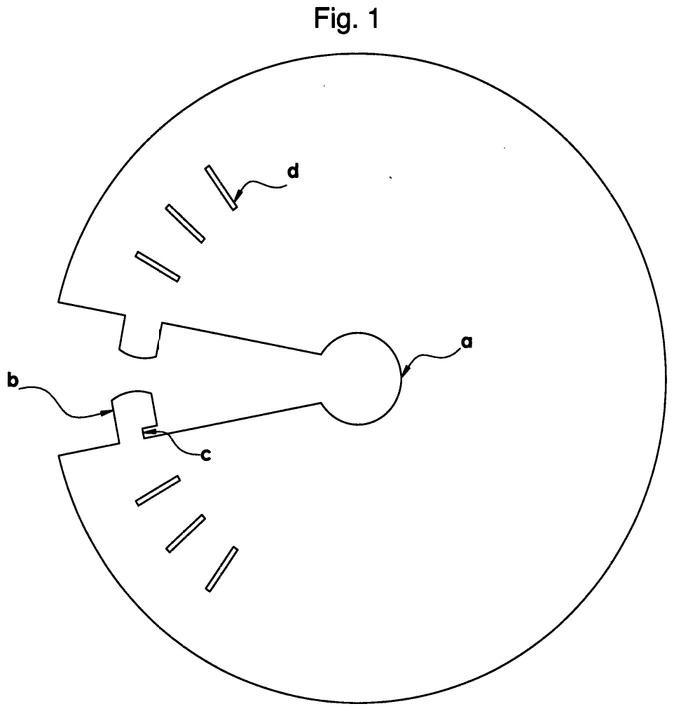

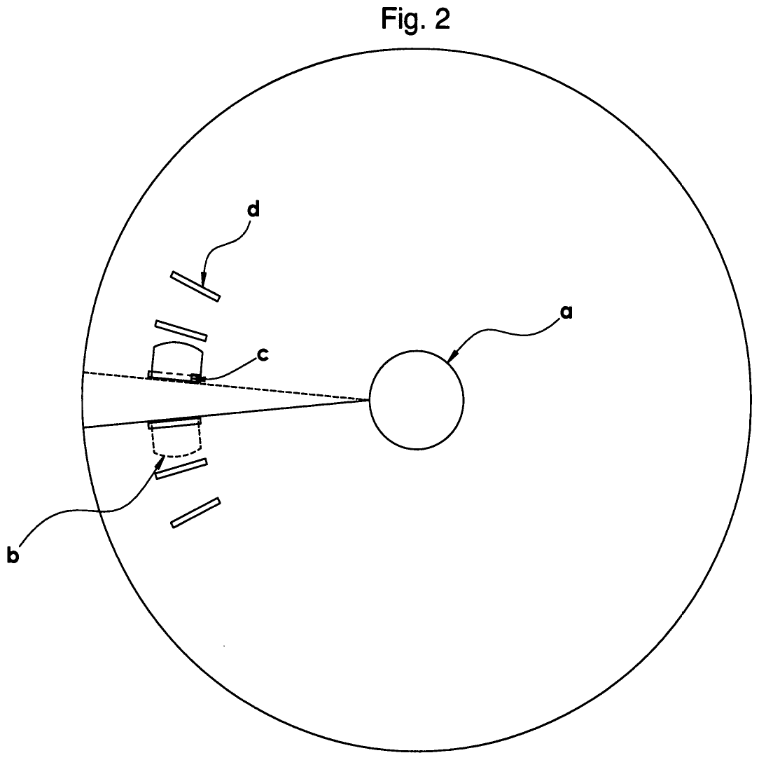

Light Bib is constructed of a thin semi ridged material with a mirrored surface. The disc has a wedge removed from the perimeter to the center. At the disk center is a hole large enough to accommodate and receive a plant stalk (FIG. 1 reference character .a) Along each edge running from the perimeter to the center hole is a tung protrusion (FIG. 1 reference character .b) one tung has a latch notch (FIG. 1 reference character .c). There are corresponding slots (FIG. 1 reference character .d) to receive tungs (FIG. 1 reference character .b). These slots are spaced to allow adjustment to the cone for focusing the reflective light pattern. Light Bib is slid over the base of the plant stalk. When plant stalk is positioned in disk center hole the edges are pulled together and tungs inserted into corresponding slots. Notched tung latch (FIG. 1 reference character .c) catches slot (FIG. 1 reference character .d) edge and holds disk, now a cone (FIGS. 2 & 3), in place.

### DETAILED DESCRIPTION

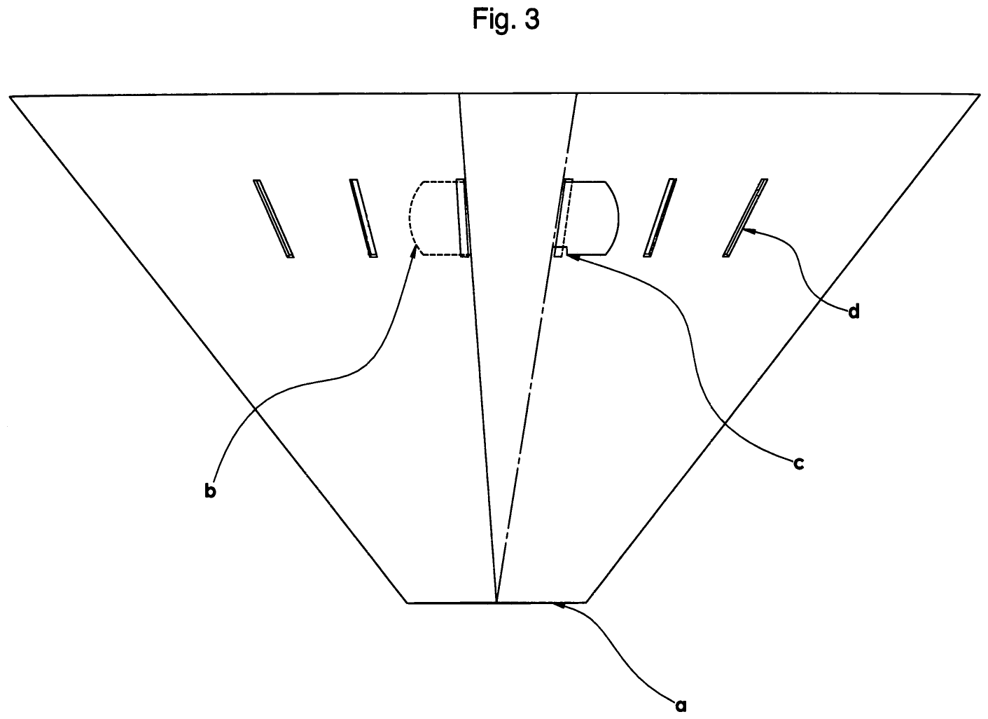

Light Bib is made utilizing a flexible mirrored disk (FIG. 1) portions of the disk are removed to create a disk that can transformed from a flat mirrored disk to a conical mirror which is placed around a plant's stalk base. After the disk is put in place it is closed (FIG. 2) and then obtains a conical shape (FIG. 3). Light Bib has several slots (FIG. 1 reference character .d) to adjust cone angle and focus reflected light. Light that passes through the plant's canopy is reflected back into the canopy instead of being absorbed by the soil increasing photosynthetically active radiation value. Light energy that would normally be wasted can instead be used by the plant, producing a higher yield for light energy expended.

### LIGHT BIB DRAWINGS FIGURES DESCRIPTION

FIG. 1: Top view, Open Position

FIG. 2: Top view, Closed Position

FIG. 3: Side view, Closed Position

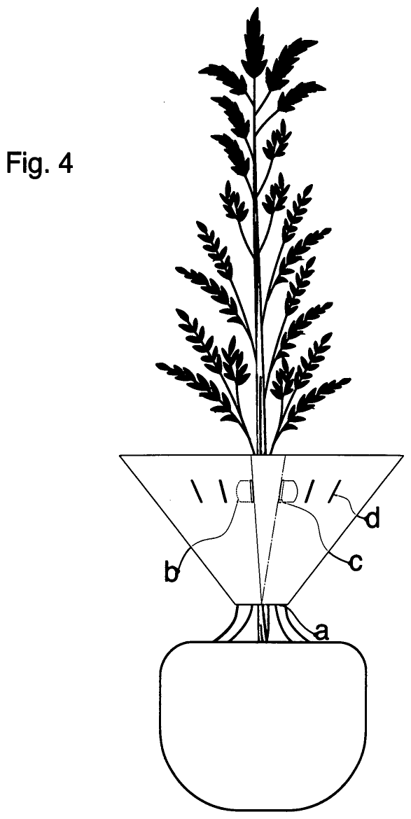

FIG. 4: Side view, In place at the base of plant

1. The claim of this invention is the utilization of a single piece, light reflective mirrored surface that can be transformed from a flat surface to a conical shape with the ability to be positioned around and removed from a plant's stalk.
